(19) United States
(12) Patent Application Publication
(10) Pub. No.: US 2015/0375924 A1
(43) Pub. Date: Dec. 31, 2015

(54) Confectionary Transport Apparatus

(71) Applicant: Jacqueline Rodriguez, New City, NY (US)

(72) Inventor: Jacqueline Rodriguez, New City, NY (US)

(21) Appl. No.: 14/315,161

(22) Filed: Jun. 25, 2014

(51) Int. Cl. B65D 85/60; B65D 81/18; B65D 25/10

(52) U.S. Cl. CPC B65D 85/60; B65D 25/108; B65D 81/18; B65D 2585/363

(57) ABSTRACT

A chocolate mold transport apparatus operable to inhibit damage to chocolate molds during transport thereof and further being operable to provide an environment for the chocolate molds that is at a temperature that is less than that of its surroundings. The chocolate mold apparatus includes a rack assembly having a lower rack and an upper rack. The lower rack includes a plurality of cross members being parallel having a void intermediate thereto wherein disposed within the void are a plurality of mold receiving receptacles. The rack assembly further includes an upper rack positioned above the lower rack being operable to engage a support rod of a chocolate mold. The upper rack includes a plurality of slidably mounted cross members. A container is included operable to receive and store the rack assembly. The container includes thermal gel layer to provide a temperature therein that is less than that of its environment.

### FIELD OF THE INVENTION

The present invention relates generally to transport apparatus, more specifically but not by way of limitation, a confectionary transport apparatus that is operable to provide damage free transportation of confectionary products and wherein the transport apparatus is operable to provide a temperature that is less than that of its surroundings.

### BACKGROUND

The confectionary business has been a rapidly growing industry over the last several years in the United States. Specialty stores producing a range of bakery and confectionary products are located in most cities. These specialty stores produce items such as cupcakes and custom chocolate creations. One common type of chocolate confections are chocolate lollipop molds. These confections are manufactured using a traditional lollipop stick but instead of hard candy, the edible portion is manufactured from chocolate in a multitude of shapes. These confectionary items are available either directly in a store or can be ordered online through the retailer.

One problem with ordering chocolate molds is the safe transportation thereof. Whether a customer orders directly at a store or through an online channel the chocolate molds are transported to a desired location. This can be as simple as a store customer taking the chocolate molds to their house or an order fulfillment broker filling the online order and shipping the chocolate molds to the location desired by the customer. Chocolate molds are typically very fragile and must be transported with care so as not to damage during transportation. Existing transport consists of conventional packaging and does not provide sufficient support to prevent breakage of the chocolate molds during transportation thereof.

Another issue with conventional packaging and shipping of chocolate molds is that there is no device that provides structural support for the chocolate molds and further provides a temperature that is required in order to eliminate any melting that may occur during shipment of the chocolate molds.

Accordingly, there is a need for a chocolate mold transport apparatus that is operable to provide physical support for a plurality of chocolate molds so as to inhibit breakage during shipment and further provide temperature isolation so as to maintain a temperature within the transport apparatus that prevents melting.

### SUMMARY OF THE INVENTION

It is the object of the present invention to provide a chocolate mold transport apparatus that is operable to provide physical support for a plurality of chocolate molds so as to eliminate breakage during transportation.

Another object of the present invention is to provide a chocolate mold transport apparatus that is operable to provide an environment having a temperature that functions to prevent melting of the chocolate molds disposed therein.

A further object of the present invention is to provide a chocolate mold transport apparatus that includes a container having a plurality of walls, a bottom and a top covering an opening wherein the plurality of walls and bottom are manufactured having a thermal gel layer.

An additional object of the present invention is to provide a chocolate mold transport apparatus that includes a rack assembly disposed within the interior volume that is operable to receive a plurality of chocolate molds.

Yet a further object of the present invention is to provide a chocolate mold transport apparatus wherein the rack assembly includes a lower rack and an upper rack that are configured to provide structural support for a plurality of chocolate molds.

Still another object of the present invention is to provide a chocolate mold transport apparatus wherein the lower rack of the rack assembly includes a plurality of receptacle portions that are operable to mateably receive a portion of the top of a chocolate mold.

A further object of the present invention is to provide a chocolate mold transport apparatus wherein the plurality of receptacle portions of the lower rack can be manufactured in numerous different shapes to accommodate a multitude of styles of chocolate molds.

Another object of the present invention is to provide a chocolate mold transport apparatus wherein the upper rack of the rack assembly is configured to engage the support rod of the chocolate mold.

An additional object of the present invention is to provide a chocolate mold transport apparatus having a rack assembly with an upper rack wherein the upper rack includes movable cross members to provide engagement of the support rod of the chocolate mold.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the rack system of the present invention; and

FIG. 2 is a perspective view of an embodiment of the external container of the present invention.

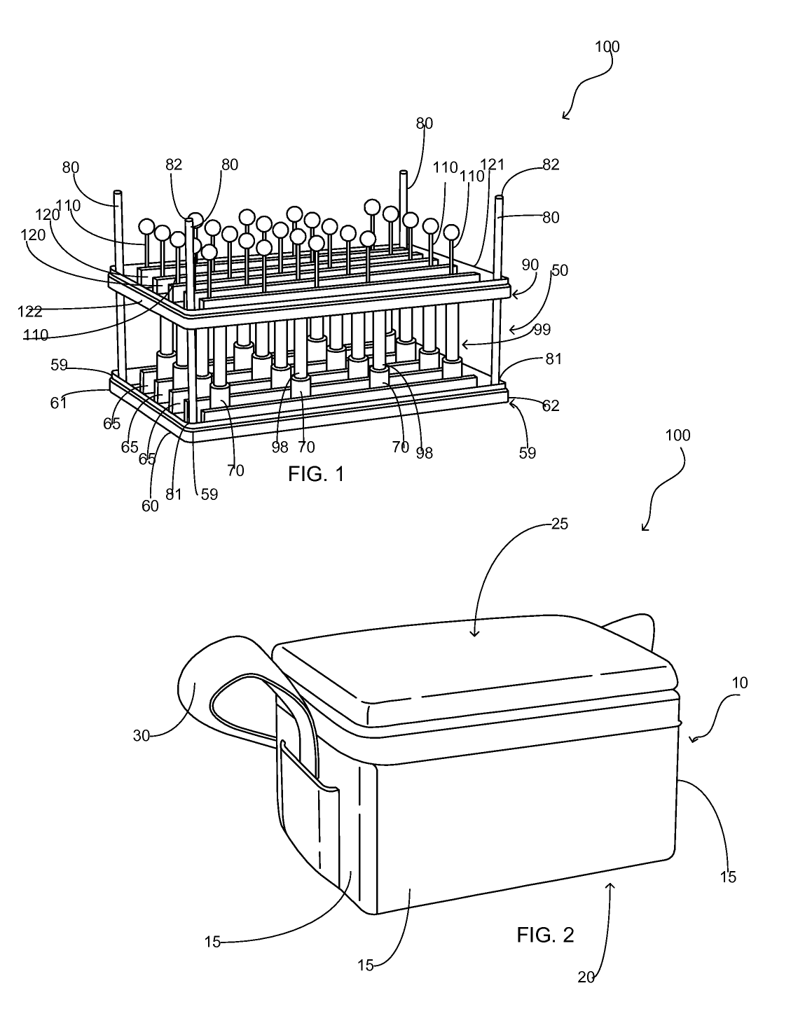

### DETAILED DESCRIPTION

Referring now to the drawings submitted herewith, wherein various elements depicted therein are not necessarily drawn to scale and wherein through the views and figures like elements are referenced with identical reference numerals, there is illustrated a chocolate mold transport apparatus 100 constructed according to the principles of the present invention.

Referring in particular to the drawings submitted herewith, the chocolate mold transport apparatus 100 further includes a container 10. The container 10 further includes a plurality of walls 15, a bottom 20 and a top 25 forming an interior volume of suitable size to receive a rack assembly 50 therein. The container 10 is generally rectangular in shape and is manufactured from a suitable durable rigid material. The walls 15 an bottom 20 are integrally formed to create an opening operable to provide access to the interior volume of the container 10. The walls 15 and bottom 20 include a thermal gel layer (not specifically illustrated herein) that is operable to maintain a temperature within the interior volume that is cooler than that of its surroundings. It is contemplated within the scope of the present invention that the other material in addition to and/or in combination with the thermal gel layer could be utilized to maintain a temperature within the interior volume of the container 10 that is less than that of its surroundings. The top 25 is hingedly attached utilizing suitable techniques. A strap 30 is included to provide a means for transporting the container 10. While a strap 30 is included in the embodiment illustrated herein, it is further contemplated within the scope of the present invention that the container 10 may be manufactured without a strap 30 for situations when it is not required such as but not limited to shipping. It is further contemplated within the scope of the present invention that the container 10 could be manufactured in numerous different sizes, shapes and colors.

Referring in particular to FIG. 2 herein, an embodiment of the rack assembly 50 is illustrated therein. The rack assembly 50 is operable to receive a plurality of exemplary chocolate molds 99 and provide support thereof during transportation and/or shipment of the chocolate mold transport apparatus 100. The rack assembly 50 is of suitable size so as to be inserted into the interior volume of the container 10. The rack assembly 50 includes a lower rack 60 that is generally rectangular in shape and manufactured from a suitable durable material such as but not limited to plastic. While a rectangular lower rack 60 is illustrated herein, it is contemplated within the scope of the present invention that the lower rack 60 could be formed in numerous different sizes and shapes. The lower rack 60 includes a plurality of lower cross members 65 that extend across the lower rack 60 intermediate the first side 61 and second side 62. The lower cross members 65 are generally rectangular in shape and are manufactured from a suitable durable material such as but not limited to plastic. The lower cross members 65 are operable to provide structural support for the mold receiving receptacles 70. While not particularly illustrated herein, it is contemplated within the scope of the present invention that the lower cross members 65 are manufactured to include an inner core that is either a thermal gel or liquid that is operable to be frozen prior to insertion into the interior volume of the container 10. This functionality will further assist in the prevention of the melting of the exemplary chocolate molds 99 during transportation thereof. Those skilled in the art will recognize that that numerous different types of thermal material could be used in the inner core of the lower cross members 65.

Integrally formed with the lower rack 60 proximate each corner 59 thereof is a mounting post 80. The mounting posts 80 are manufactured from a suitable durable material such as but not limited to plastic. The mounting posts 80 include a first end 81 that is integrally formed with the lower rack 60 and a second end 82 that is distal to the lower rack 60. The mounting posts 80 are cylindrical in shape and extend upward from the lower rack 60 being perpendicular thereto. The mounting posts 80 are operable to releasably receive the upper rack 90. While not particularly illustrated herein, it is contemplated within the scope of the present invention that the mounting posts 80 include a fastener operable to engage the upper rack 90 so as to secure the upper rack 90 in a desired position so as to engage the support rods 110 of the exemplary chocolate molds 99. Those skilled in the art will recognize that numerous types of conventional fasteners could be utilized to releasably secure the upper rack 90 in a desired position on the mounting posts 80.

Integrally formed intermediate the lower cross members 65 are the mold receiving receptacles 70. The mold receiving receptacles 70 are formed so as to mateably receive and support the top portion 98 of the exemplary chocolate molds 99. The top portion 98 of the exemplary chocolate molds are partially inserted in to the mold receiving receptacles 70 so as to provide support operable to inhibit movement and damage to the exemplary chocolate molds 99 during transportation thereof. The mold receiving receptacles 70 are manufactured in a shape so as to mateably receive a top portion 98 of an exemplary chocolate mold 99. More specifically but not by way of limitation, it is contemplated within the scope of the present invention that the mold receiving receptacles 70 are formed in a variety of shapes in addition to the cylindrical shape illustrated herein. It is further contemplated within the scope of the present invention that the amount of mold receiving receptacles 70 present intermediate the lower cross member 65 is dictated by the size of the mold receiving receptacles 70. It is further contemplated within the scope of the present invention that the amount of lower cross members 65 is a function of the size and shape of the mold receiving receptacles 70.

The upper rack 90 is manufactured similarly to the lower rack 60 wherein the upper rack 90 is rectangular in shape being manufactured from a suitable durable material such as but not limited to plastic. It is further contemplated within the scope of the present invention that the upper rack 90 further includes an inner core manufactured from a suitable thermal material that is operable to maintain a temperature that is cooler than its surroundings. The upper rack 90 includes a plurality of upper cross members 120 that extend intermediate the first side 121 and second side 122 of the upper rack 90. The upper cross members 120 are rectangular in shape and are operable to engage the support rods 110 so as to maintain the exemplary chocolate molds 99 in a substantially vertical position. The upper cross members 120 are slidably secured within the upper rack 90 utilizing conventional fasteners. The slidable configuration of the upper cross members 120 allow a user to manipulate the position of the upper cross members 120 so that the upper cross members 120 are biased against opposing sides of the support rods 110 in order to assist in maintaining a substantially vertical position of the exemplary chocolate molds 99.

Referring to the drawings herewith, a description of the operation of the chocolate mold transport apparatus 100 is as follows. In use, a user will place a plurality of exemplary chocolate molds 99 in an inverted position such that the top portion 98 is at least partially inserted into the mold receiving receptacles 70. Subsequent the placement of the exemplary chocolate molds 99, the upper rack 90 is positioned along the mounting posts 80. Ensuing positioning of the upper rack 90, the upper cross members 120 are slidably moved so as to bias against opposing sides of the support rods 110. Once the exemplary chocolate molds 99 are secured within the rack assembly 50, the rack assembly 50 is inserted into the interior volume of the container 10. The container 10 has been pre-cooled so as to ensure the interior volume thereof maintains a temperature that is lower than that of its surroundings to inhibit the melting of the exemplary chocolate molds 99.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A confectionary transport apparatus comprising:
a container, said container having a plurality of walls and a bottom operable to form an interior volume, said container having an opening, said container having a top operable to cover said opening;
a rack assembly, said rack assembly having a lower rack and an upper rack, said rack assembly being removably disposed within the interior volume of said container, said lower rack assembly configured to engage at least a portion of a confectionary item, said upper rack assembly being operable to engage a support rod of the confectionary item; and
wherein the confectionary transport apparatus is operable to maintain a plurality of confectionary items in a vertical position and further maintain a temperature that is lower than that of its surroundings within the interior volume of said container.

2. The confectionary transport apparatus as recited in claim 1, wherein said lower rack includes a plurality of lower cross members, said lower cross members extending across said lower rack, said lower cross members being parallel having a space intermediate thereto.

3. The confectionary transport apparatus as recited in claim 2, and further including a plurality of mold receiving receptacles, said plurality of mold receiving receptacles mounted within the space intermediate said lower cross members, said mold receiving receptacles operable to receive a portion of a confectionary item.

4. The confectionary transport apparatus as recited in claim 3, and further including a plurality of upper cross members, said upper cross members being mounted to said upper rack, said upper cross members extending across said upper rack, said upper cross members operable to engage a support rod of a confectionary item.

5. The confectionary transport apparatus as recited in claim 4, and further including mounting posts, said mounting posts secured to said lower rack and extending upward therefrom, said mounting posts operable to receive thereon said upper rack.

6. The confectionary transport apparatus as recited in claim 5, wherein said upper cross members are slidably mounted to said upper rack.

7. The confectionary transport apparatus as recited in claim 6, wherein said rack assembly further includes a thermal material layer operable to maintain a temperature that is less than that of its environment.

8. A confectionary transport apparatus operable to inhibit breakage of confectionary items during transport thereof and further operable to provide a temperature that is less than that of its surroundings comprising:
a container, said container having a four walls and a bottom operable to form an opening operable to provide access to an interior volume, said container having a top operable to cover said opening, said container being rectangular in shape, said four walls further including a thermal gel layer;
a rack assembly, said rack assembly having a lower rack and an upper rack, said lower rack being rectangular in shape, said upper rack being rectangular in shape, said rack assembly being removably disposed within the interior volume of said container, said lower rack assembly configured to engage at least a portion of a confectionary item so as to provide support therefore during transportation, said upper rack assembly being operable to engage a support rod of the confectionary item, said upper rack being mounted above said lower rack and being in alignment therewith; and
wherein the confectionary transport apparatus is operable to maintain a plurality of confectionary items in a vertical position so as to inhibit damage thereto.

9. The confectionary transport apparatus as recited in claim 8, wherein said lower rack further includes a plurality of cross members, said cross members extending across said lower rack, said cross members being parallel in configuration having a void intermediate thereto.

10. The confectionary transport apparatus as recited in claim 9, and further including a plurality of mold receiving receptacles, said plurality of mold receiving receptacles having a cavity operable to receive a portion of a confectionary item, said plurality of mold receiving receptacles mounted within the void intermediate said cross members.

11. The confectionary transport apparatus as recited in claim 10, wherein said upper rack further includes a plurality of upper cross members, said upper cross members extending across said upper rack, said upper cross members being parallel with respect to each other, said upper cross members operable to engage a portion of a support rod of a confectionary item.

12. The confectionary transport apparatus as recited in claim 11, and further including four mounting posts, said four mounting posts being secured to said lower rack and extending upward therefrom, said four mounting posts operable to couple said lower rack with said upper rack.

13. The confectionary transport apparatus as recited in claim 12, wherein the upper cross members are slidably mounted to said upper rack.

14. The confectionary transport apparatus as recited in claim 13, wherein the rack assembly further includes an inner core layer, said inner core layer being manufactured from a thermal material operable to maintain a temperature that is less than that of its surroundings.

15. A chocolate mold transport apparatus operable to inhibit damage to chocolate molds during transportation and provide an environment that is at a temperature less than that of its surroundings comprising:
a container, said container having a four walls and a bottom operable to form an opening operable to provide access to an interior volume, said container having a top operable to cover said opening, said container being rectangular in shape, said four walls further including a thermal gel layer;
a rack assembly, said rack assembly having a lower rack and an upper rack, said lower rack being rectangular in shape, said lower rack having a first end and a second end, said lower rack having four corners, said upper rack being rectangular in shape, said upper rack having a first end and a second end, said upper rack having four corners, said rack assembly being removably disposed within the interior volume of said container, said lower rack assembly configured to engage at least a portion of a chocolate mold so as to provide support therefore during transportation, said upper rack assembly being operable to engage a support rod of a chocolate mold, said upper rack being mounted above said lower rack and being in alignment therewith;
a plurality of mold receiving receptacles, said mold receiving receptacles being mounted to said lower rack, said plurality of mold receiving receptacles operable to be mateably shaped with and receive a portion of a chocolate mold; and
wherein the chocolate mold transport apparatus is operable to maintain a plurality of chocolate molds in a vertical position so as to inhibit damage thereto.

16. The chocolate mold transport apparatus as recited in claim 15, wherein said lower rack further includes a plurality of cross members, said cross members extending across said lower rack intermediate said first end and said second end, said cross members being parallel in configuration having a void intermediate thereto.

17. The chocolate mold transport apparatus as recited in claim 16, wherein said upper rack further includes a plurality of upper cross members, said upper cross members extending across said upper rack intermediate said first end and said second end, said upper cross members being parallel with respect to each other, said upper cross members operable to engage a portion of a support rod of a chocolate mold.

18. The chocolate mold transport apparatus as recited in claim 17, wherein the upper cross members are slidably mounted to said upper rack.

19. The chocolate mold transport apparatus as recited in claim 18, and further including four mounting posts, said four mounting posts having a first end and a second end, said four mounting posts being secured to said lower rack and extending upward therefrom, said four mounting posts operable to couple said lower rack with said upper rack, said upper rack being releasably secured to said four mounting posts proximate said second ends.

20. The chocolate mold transport apparatus as recited in claim 19, wherein the rack assembly further includes an inner core layer, said inner core layer being manufactured from a thermal material operable to maintain a temperature that is less than that of its surroundings.
